(19) United States
(12) Patent Application Publication
(10) Pub. No.: US 2008/0218247 A1
(43) Pub. Date: Sep. 11, 2008

(54) METHOD FOR AUTOMATICALLY ADJUSTING ELECTRICAL FUSE PROGRAMMING VOLTAGE

(75) Inventors: Byeongju Park, Plainview, NY (US); John M. Safran, Wappingers Falls, NY (US)

Correspondence Address: SCULLY, SCOTT, MURPHY & PRESSER, P.C., 400 GARDEN CITY PLAZA, Suite 300, GARDEN CITY, NY, 11530, US

(73) Assignee: INTERNATIONAL BUSINESS MACHINES CORPORATION, Armonk, NY (US)

(21) Appl. No.: 11/683,081

(22) Filed: Mar. 7, 2007

(51) Int. Cl. H01H 37/76

(52) U.S. Cl. 327/525

(57) ABSTRACT

The present invention provides a circuit for determining the optimal gate voltage for programming transistors. The determination of the optimal voltage compensates for the variations in the programming current due to process variations in manufacturing or due to ambient conditions. By applying the optimal gate voltage thus determined to the programming transistors of electrical fuses, the optimal level of current is passed through the electrical fuses to enable high yielding and reliable electrical fuse programming.

### FIELD OF THE INVENTION

The present invention relates to semiconductor circuitry, and particularly, to semiconductor fuse programming circuitry.

### BACKGROUND OF THE INVENTION

Electrically programmable fuses are utilized within the field of semiconductor integrated circuit devices for a number of purposes, including the storage of unalterable information for permanent memory, selection of a particular configuration from among many possible circuit configurations, optimizing the value of a particular analogue circuit component, optimizing overall circuit performance, and/or replacing defective circuit elements with redundant circuit elements.

Electrical fuses may be programmed on a tester before packaging of a chip in an environment where a stable voltage supply is available, inside an operational computer where the voltage supply is less stable, or in hand held devices where the power source is often a battery with a wide range of voltage variations during the operation. The number of electrical fuses in a semiconductor chip may vary between a few fuses to millions of fuses. In most configurations where multiple fuses are employed, the electrical fuses are in an array format where the voltage supplies are shared among many fuses. The array may be addressable by a scan chain or by a row and column addressing scheme. By selecting a particular electrical fuse and allowing a sufficient amount of electrical current flow through the fuse, the fuse is “programmed.” Once the electrical fuse programs, the electrical resistance of the fuse changes and the sense circuit detects the change of the resistance to read the stored information.

FIG. 1 illustrates a conventional electrical fuse circuitry 50. The circuit 50 consists of a fuse 10 a programming transistor 20 connected in series to the fuse 10, a voltage supply 40, commonly referred to as F-source voltage, which is connected to the fuse 10, and another voltage supply 30 connected to the gate of the programming transistor 20. When the programming of the electrical fuse is desired, the F-source voltage is supplied and the voltage to the gate of the programming transistor is pulsed to pass electrical current through the fuse. The current causes electromigration of the material in the electrical fuse, which changes its resistance as a result of the electromigration. A typical electrical fuse 70 is shown in FIG. 2. The fuse 70 in FIG. 2 has a cathode 71, from which electromigrating material originates during programming of the fuse, a fuselink 72 through which the electromigrating material moves, and an anode 73 in which the electromigrated material piles up.

Programming of the electrical fuses with high yield requires a controlled amount of programming current from the programming transistor. Too low programming current underprograms the fuse and results in lower post-programming fuse resistance, and thus causes the programmed fuses to be erroneously sensed as intact fuses. Likewise, too high programming current causes the temperature of the electrical fuse to rise too high, causing ruptures of the fuses, which tends to produce some low resistance fuses statistically, thereby causing the programmed fuses to be sensed erroneously. In general, an optimal programming current window exists for electrical fuses that produces reliable post-programming fuse resistance distribution and high sense yield.

The control of the programming current is critical in insuring that the fuses are programmed properly. In addition, there are cases where the programming current variation is amplified beyond what is normally specified in the device specifications, such as programming of electrical fuses inside a computer while the computer is operational and the ambient temperature of the circuit is hard to predict or programming inside a mobile battery powered device in which the conditions of power supply, e.g., a battery, may have large variations during the usage. Whether caused during the manufacture of the semiconductor chips or whether due to the external conditions during the operation of the semiconductor chips, variations in the programming current invariably degrades the yield and reliability of the electrical fuses. In view of the above, a need exists for a circuit that adjusts the programming current near a target value even in the presence of adverse process or ambient conditions that cause significant changes in the transistor performance.

### SUMMARY OF THE INVENTION

The present invention addresses the above-described problems by providing a circuit that can adjust the variations in the programming current through the electrical fuse. As can be seen in FIG. 1, the F-source supply voltage, V_fs, is divided between the electrical fuse and the programming transistor. Given the relative stability of the initial resistance of the fuse and the target programming current through the fuse, the voltage drop across the fuse, V_fuse, can be easily calculated. By subtracting V_fuse from the F-source supply voltage, V_fs, the desired voltage across the programming transistor, V_ds, can be obtained as well. Turning on the programming transistor by elevating the transistor gate voltage to an on-voltage, V_gs, while the F-source supply voltage, V_fs is applied to a serial connection of a fuse and a programming transistor causes the programming of the fuse. However, measurement of the initial voltage drop across the programming transistor is very difficult since the resistance of the fuse begins to change immediately after the voltage conditions are applied.

In accordance with one aspect of this invention, a simulated fuse load circuit element is provided that is electrically equivalent to an intact fuse but does not change resistance in time. The embodiments of this circuit element include: large fuses where dimensions are proportionally enlarged from typical electrical fuses, a 2×2 array of electrical fuses in a series connection, a 2×2 array of electrical fuses in a parallel connection, an N×N array of resistive elements in a series connection with the resistance equivalent to that of an intact single fuse where N is greater than 2, and an N×N array of electrical fuses in a parallel connection with the resistance equivalent to that of an intact single fuse where N is greater than 2.

In accordance with another aspect of this invention, a circuit is provided to determine the optimal gate voltage for the programming transistor to enable the centering of the programming current through the fuses. By substituting a simulated fuse load for a fuse in the circuit consisting of a serial connection of the fuse and the programming transistor, the initial programming current in a serial connection of the fuse and the programming transistor can be estimated.

In accordance with yet another aspect of this invention, a circuit that determines the optimal gate voltage for programming transistors during the electrical fuse programming is provided. The voltage drop across a programming transistor is compared in a comparator with the externally provided reference voltage that corresponds to the ideal initial voltage drop across the programming transistor. A latching circuitry that generates a series of increasing or decreasing voltages is connected to the gate of the programming transistor to measure the voltage drop across the programming transistor at various voltage conditions applied to the gate. When the output of the comparator flips during the voltage sweep on the gate, the circuitry holds the value in the latch that is stored at that time. This voltage setting may be frozen or stored and then applied to the gates of the programming transistors connected to other fuses during the electrical fuse programming process. Alternatively, the digital value held in the latch may be used to recreate the gate voltage on the programming transistors during programming of other fuses.

In accordance with yet another aspect of this invention, the external reference voltage described above is internally supplied with a voltage divider circuit.

In a first embodiment of the voltage divider circuit, the reference voltage is derived from the F-source supply voltage through a circuit consisting of resistors.

In a second embodiment of the voltage divider circuit, the reference voltage is derived from the F-source supply voltage through a circuit comprising resistors and diodes.

In a third embodiment of the voltage divider circuit, the reference voltage is derived from the F-source supply voltage through a circuit comprising resistors and fuses or resistors and circuit elements that electrically simulate fuses.

### BRIEF DESCRIPTION OF THE DRAWINGS

FIG. 1 is a diagram illustrating a typical electrical fuse programming circuit comprising an electrical fuse and a programming transistor connected in series.

FIG. 2 is a diagram illustrating the shape of a typical electrical fuse.

FIG. 3 is a diagram illustrating a circuitry for determining the optimal gate voltage for programming electrical fuses according to the present invention.

FIG. 4 is a diagram illustrating the variation of the programming transistor current.

FIG. 5(a) is a diagram illustrating an embodiment of a simulated fuse load which is made of a structure obtained by proportionately enlarging the dimensions of an electrical fuse.

FIG. 5(b) is a diagram illustrating an embodiment of a simulated fuse load which is made of a structure obtained by a parallel connection of two serial connections of two electrical fuses.

FIG. 5(c) is a diagram illustrating an embodiment of a simulated fuse load which is made of a structure obtained by a series connection of two parallel connections of two electrical fuses.

FIG. 5(d) is a diagram illustrating an embodiment of a simulated fuse load which is made of a structure obtained by a parallel connection of N serial connections of N electrical fuses, where N is an integer greater than 2.

FIG. 5(e) is a diagram illustrating an embodiment of a simulated fuse load which is made of a structure obtained by a series connection of N parallel connections of N electrical fuses, where N is an integer greater than 2.

FIG. 6(a) is a diagram illustrating an embodiment of a reference voltage generator circuit according to the present invention where the circuit consists of resistors.

FIG. 6(b) is a diagram illustrating an embodiment of a reference voltage generator circuit according to the present invention where the circuit consists of resistors and diodes.

FIG. 6(c) is a diagram illustrating an embodiment of a reference voltage generator circuit according to the present invention where the circuit consists of resistors and electrical fuses.

### DETAILED DESCRIPTION OF THE INVENTION

As stated above, the present invention describes a circuit for determining the optimal gate voltage for programming transistors to compensate for normal manufacturing process variations in the programming current of a programming transistor in an electrical fuse circuitry. This is achieved through the measurement of the voltage drop across the programming transistor in a circuit comprising the programming transistor in a series connection with a simulated fuse load. The simulated fuse load is a circuit element that mimics the electrical characteristics of an electrical fuse but does not program under the electrical fuse programming conditions. A gate voltage that produces the optimal level of voltage drop across the programming transistor is determined by comparing the voltage between the programming transistor and the simulated fuse load with a reference voltage.

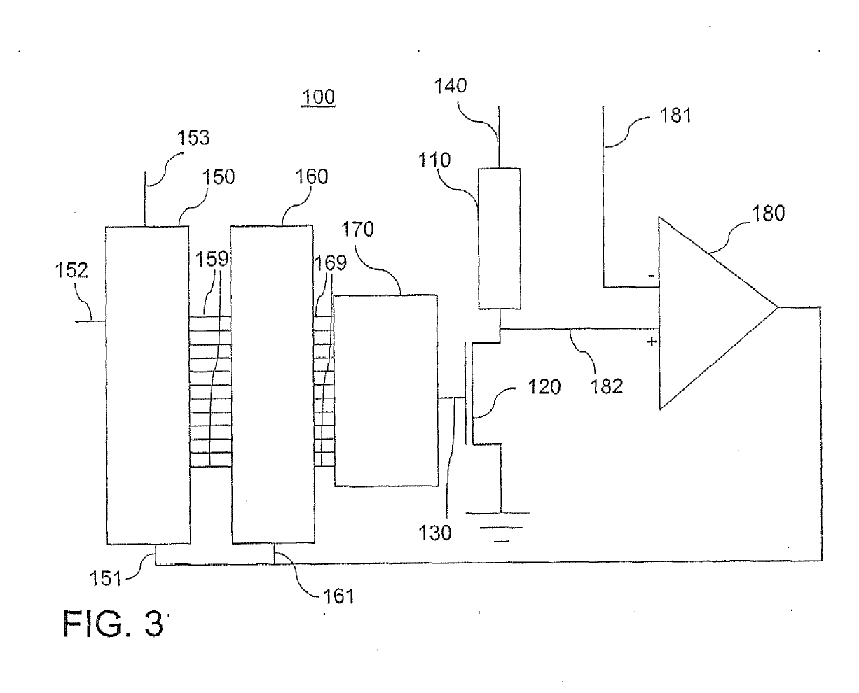

FIG. 3 illustrates a circuit 100 for determining the optimal gate voltage for programming transistors of the electrical fuses according to this invention. This circuit 100 comprises a simulated fuse load 110, a programming transistor 120, a voltage comparator 180, a counter 150, a latch 160, and a digital to analog converter 170. As the voltage on the gate of the programming transistor 120 monotonically varies when the counter 150 and latch 160 are enabled, the voltage at the node between the transistor 120 and the simulated fuse load 110 is fed to the first input 182 of the voltage comparator 180. The voltage at the first input 182 is compared with the reference voltage applied to the second input 181, which may be externally supplied to generate an output to be fed to the counter 150 and latch 160. The counter 150 and latch 160 setting that flips the voltage comparator 180 is the voltage that generates the optimal gate voltage for the programming transistor 120. The comparator 180 output voltage flip is used to disable the counter 150 and hold the value in the latch 160.

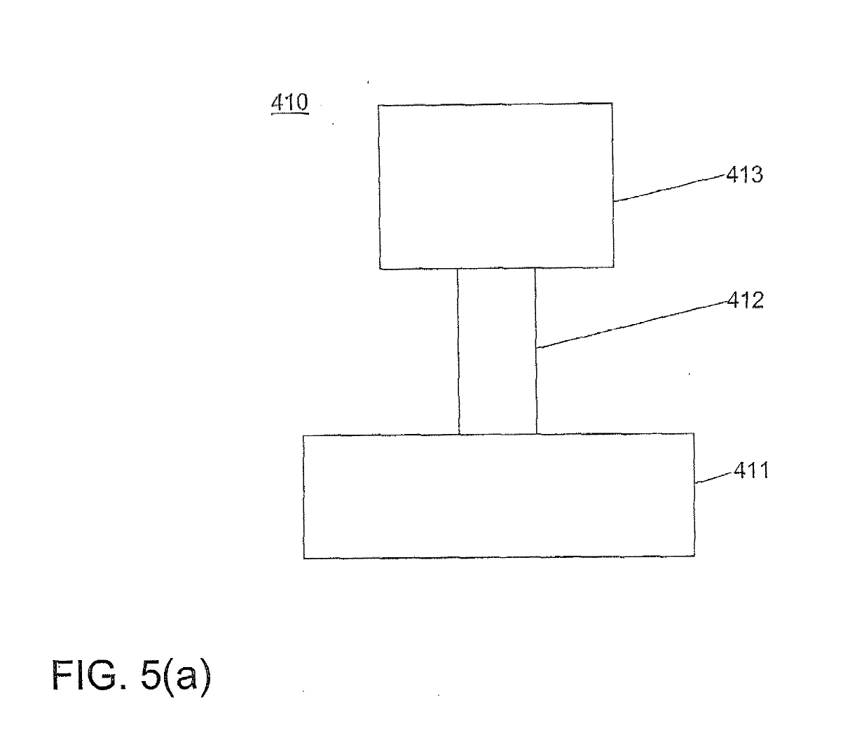

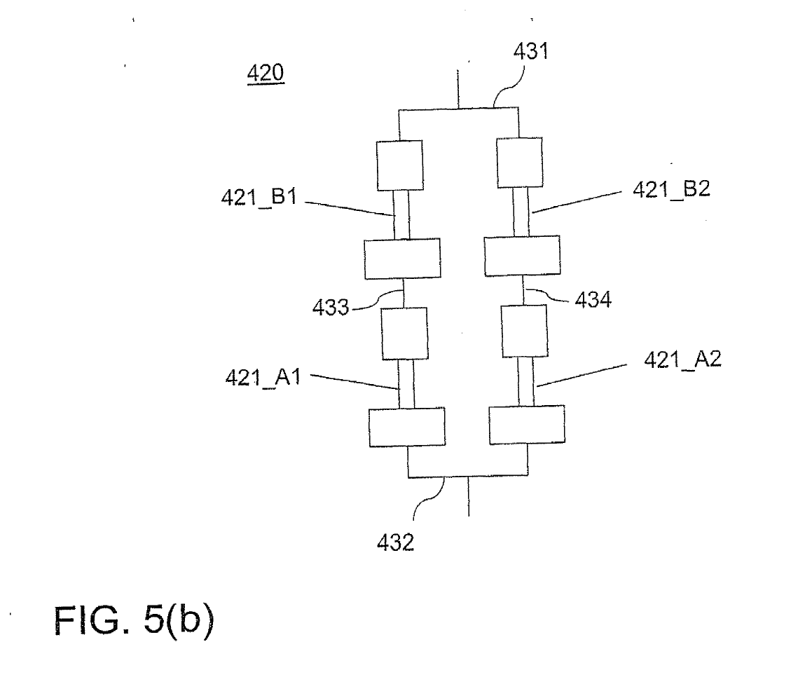

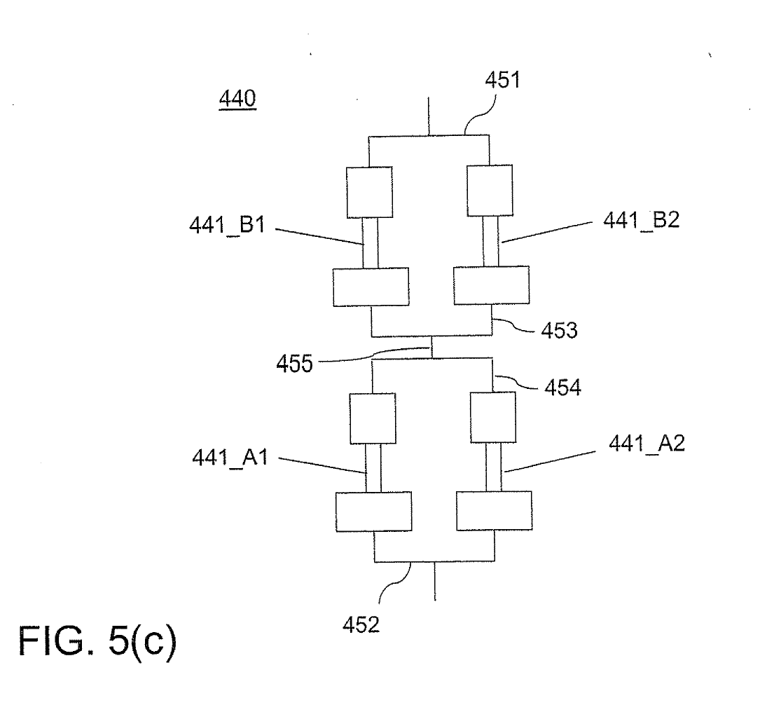

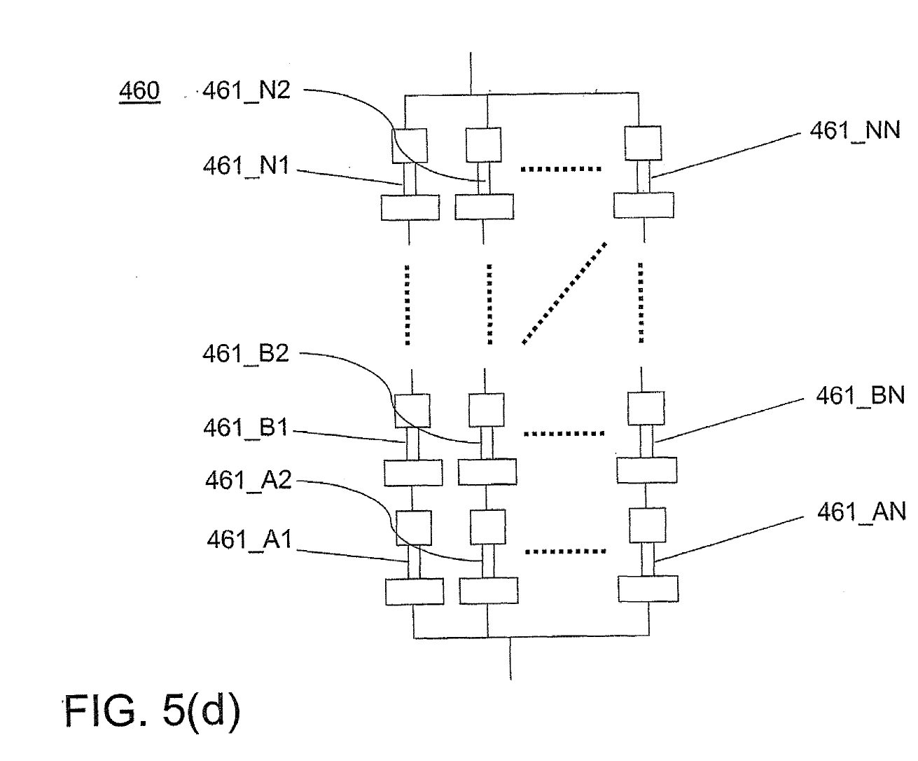

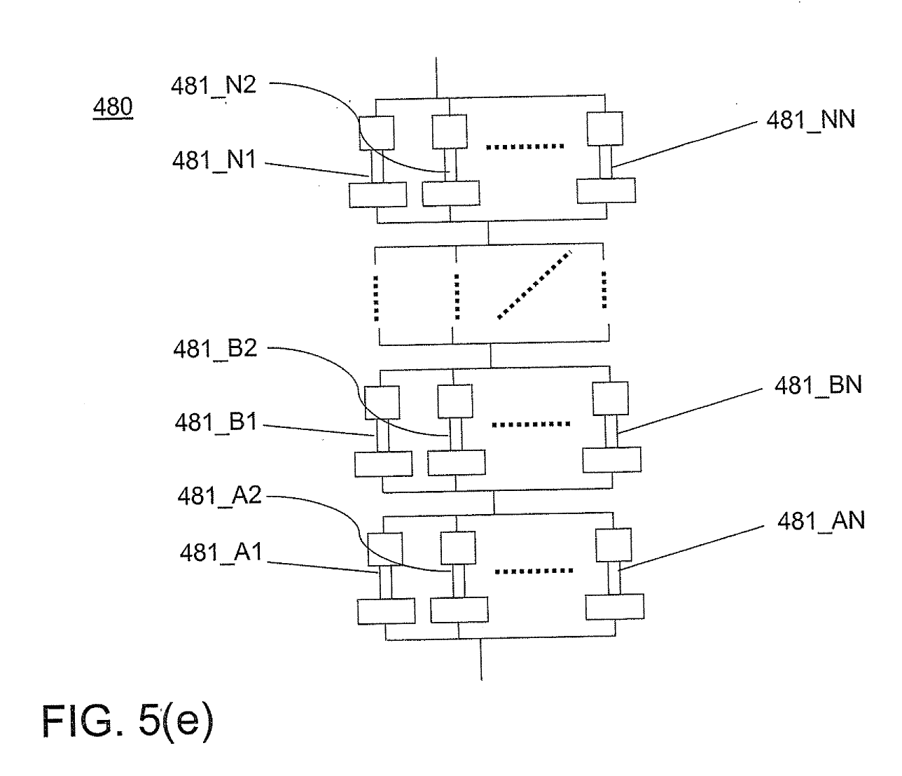

In this circuit, the simulated fuse load 110 is a resistive circuit component that mimics the resistance of the electrical fuse but, unlike an electrical fuse, it is structurally stable enough not to change electrical characteristics even when electrical current which would be sufficient to program an electrical fuse is passed through it. In other words, the simulated fuse load has the same electrical resistance as an intact electrical fuse but the structure itself is robust enough to withstand the passage of the current equivalent to the programming current of a fuse. Specific embodiments of the simulated fuse load 110 are disclosed in FIGS. 5(a)-5(e) and described below.

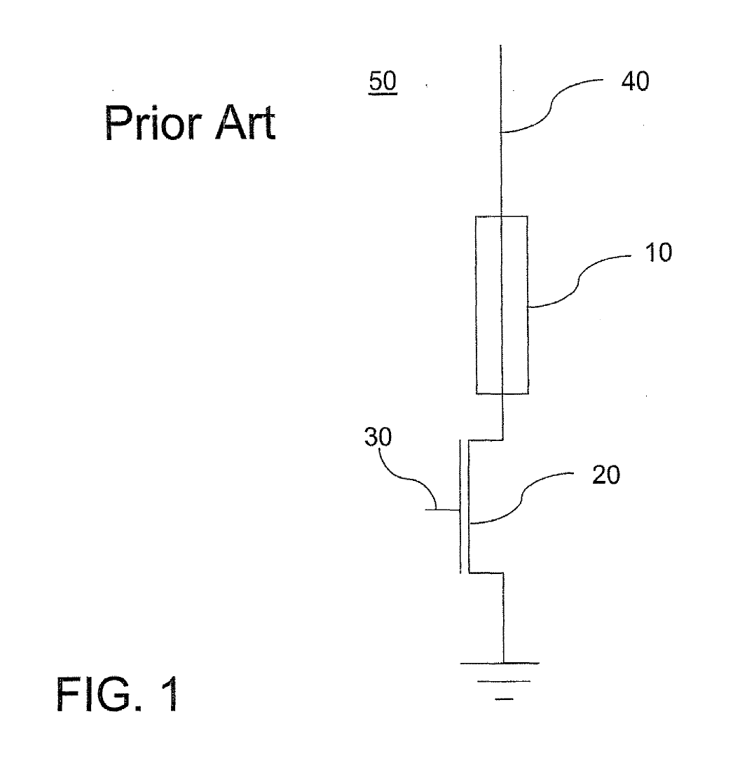

The programming transistor 120 in the circuit 100 in FIG. 3 is a replica of the programming transistor 20 for an electrical fuse programming circuit 50 in FIG. 1. Since the purpose of the programming transistor 120 in FIG. 3 is to simulate the programming current of the programming transistor 20 in FIG. 1, an exact replica of the programming transistor 20 used in the electrical fuse programming circuit 50 is preferred for the programming transistor 120 in the circuit 100 for determining optimal voltage of programming transistors. The transistor 120 is connected to the simulated fuse load 110 in a series connection. The voltage output of the assembly of the counter 150, the latch 160, and the digital to analog voltage converter (DAC) 170 is fed into the gate 130 of the programming transistor 120.

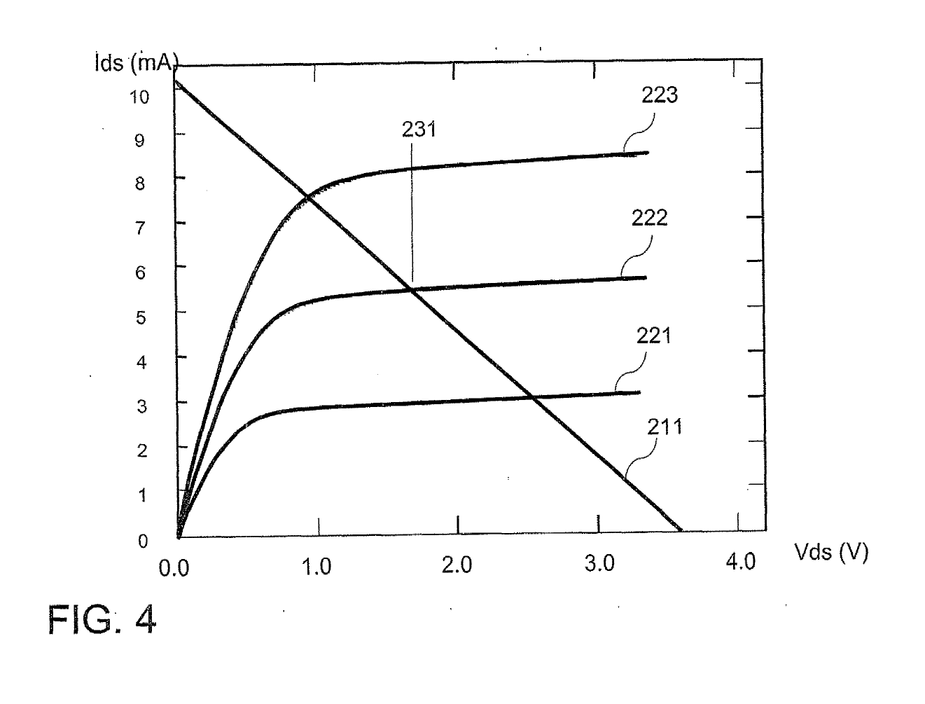

FIG. 4 illustrates transistor curves for the programming transistor 120 and the load line of the simulated fuse load 110 as is commonly used to determine the current through two circuit elements, which in this case are the programming transistor 120 and the simulated fuse load 110. The x-axis and y-axis of FIG. 4 are scaled to reflect typical operational voltage and current ranges of the electrical fuses. The ideal transistor curve 222 is a curve for a given gate voltage for an ideal programming transistor current at the center of the transistor specification and in ideal ambient conditions, for example, at the temperature for which the transistor current is specified and without any performance degradation of the transistor with usage. The transistor curve 221 is an exemplary transistor curve for the same given gate voltage where the transistor programming current is lower than the ideal value due to process variations during the manufacture and/or ambient conditions. Similarly, the transistor curve 223 is an exemplary transistor curve for the same given gate voltage where the transistor programming current is higher than the ideal value. The load line 211 is placed such that the intersect of the load line 211 with the horizontal axis (Voltage axis) is the voltage provided to the F-source 140 and the negative of the inverse of the slope is the resistance of the simulated fuse load 110 in FIG. 3. The value of the reference voltage, V_ref, applied to the second input 181 of the comparator 180 in FIG. 3 is determined by the abscissa of the intersect 231 of the ideal transistor curve 222 and the load line 211 in FIG. 4.

It is further noted that even when the actual programming transistor curve significantly deviates from the ideal programming transistor curve 222 due to variations in the manufacture process or ambient conditions, it is possible to compensate for the deviation by adjusting the voltage to the gate of the programming transistor. For example, if the actual programming transistor curve is one represented by the curve 221 in FIG. 4, the gate voltage of the programming transistor can be raised until the new transistor curve with the raised gate voltage closely resembles the ideal programming transistor curve 222. Vice versa, the gate voltage on a programming transistor represented by curve 223 can be lowered to closely match the ideal programming transistor curve 222. It must be noted that when the non-ideal transistor curves 221 and 223 are adjusted to resemble the ideal programming transistor curve 222, the intersect of the adjusted curves with the load line 211 is very close to the ideal intersect 231 of the load line and the ideal programming transistor curve 222. It follows then that when the gate voltage is adjusted for the non-ideal programming transistors, the voltage drop across the non-ideal transistors, represented by the abscissa of the intersect of the adjusted transistor curves and the load line 211, must be very close to the reference voltage, V_ref, defined by the abscissa of the intersect 231 of the ideal programming transistor and the load line 211.

The voltage at the node between the transistor 120 and the simulated fuse load 110 is fed into the first input 182 of the voltage comparator 180. The value of the reference voltage as determined by the abscissa of the intersect 231 of the ideal programming transistor 222 and the load line 211 is supplied to the second input 181 of the voltage comparator 180. When the input voltage to the first input 182 is lower than the input voltage to the second input 181, the output of the voltage comparator 180 is low. When the input voltage to the first input 182 is higher than the input voltage to the second input 181, the output of the voltage comparator 180 is high. The reference voltage applied to the second input 181 may be either externally generated and supplied to the system or internally generated from one of the other available voltages including the system power supply voltage and F-source supply voltage. The output of the voltage comparator 180 changes depending on which of the first input 182 and the second input 181 has a higher voltage. The voltage output of the voltage comparator 180 is fed into the counter 150 and the latch 160.

For the operation of the circuit 100, the counter 150 is reset by a signal to the reset input 153. With each cycle of the clock signal connected to the clock input 152, the counter 150 generates counter data outputs 159, which are parallel digital outputs from the counter 150, that corresponds to a monotonically increasing number. A full range of numbers corresponding to all possible variations of all the bits or alternatively, a partial range of numbers corresponding to a subset of all possible variations of all the bits may be digitally generated. As the digital output of the counter 150 is monotonically increased, the voltage at the count enable input 151, which is the output voltage of the voltage comparator 180, is flipped from high to low. The counter 150 stops counting with the change in the count enable input 151. The granularity of the counter is fine enough that the voltage change at the gate 130 of the programming transistor 120 corresponding to a unit count change of the counter 150 causes insignificant variation in the programming current or voltage drop across the programming transistor 120.

The output of the voltage comparator 180 is fed into the hold bar (the inverse of hold enable) input 161 of the latch 160 and monitored by the latch 160. The latch 160 transmits the data outputs 159 from the counter 150 to the digital to analog voltage converter (DAC) 170 through the latch data outputs 169, which are also parallel digital outputs, from the latch 160 as long as the hold bar input 161 remains high. As the hold bar input 161 changes from high to low, the latch 160 holds the value of the last latch data inputs, which is the same as the last counter data outputs, that it received from the counter 150 and consequently, the latch data outputs 169 of the latch 160 freezes. If there is a significant wiring length between any of the components above, signal buffers may be employed to ensure the transmission of the signal without losing the fidelity of the signal.

The digital to analog voltage converter (DAC) 170 receives the latch data outputs 169 of the latch 160 as the DAC data inputs and converts it to an analog voltage. This voltage is supplied to the gate 130 of the programming transistor 120. The output voltage range of the DAC 170 is set to cover all anticipated variations of the performance of the programming transistor 120, caused during the manufacture of the circuit and the ambient conditions, with the adjustment of the gate voltage 130 so that the voltage drop across the programming transistor 120 is sufficiently close to the reference voltage supplied to the second input 181 of the voltage comparator 180. In other words, with sufficient granularity of the digital output 159 of the counter 150, by the time the counter stops counting, the output voltage from the DAC 170 has a voltage that, when applied to the programming transistor 120 of the circuit 100 or when applied to the programming transistor 20 of an electrical fuse circuit 50, generates a voltage drop across the programming transistor 20 or 120 that is sufficiently close to the reference voltage supplied to the second input 181 of the voltage comparator 180.

The output voltage of the DAC 170 can then be applied to the gate of each of the programming transistor 20 of a conventional electrical fuse circuit 50 or an array of electrical fuse circuitry. Since the programming transistor 120 and the programming transistor 20 are built the same way, the adjusted voltage setting on the programming transistor 20 also produces a programming transistor curve that closely matches the ideal programming transistor curve 222 in FIG. 4. Thus, a targeted amount of current is passed though the electrical fuses 10 despite the transistor current variations introduced during the manufacture or ambient conditions.

While the operation of the counter, latch, and the DAC described above involved a monotonically increasing counter output, one skilled in the art would immediately recognize that a similar operation would be possible with a monotonically decreasing counter output. Also, while the operation of the circuit above was described with the count enable input 151 initially being high and then switching to low and the hold bar input 161 initially being high and then switching to low, it is immediately recognizable that the polarity of the signal is a matter of preference and that alternative polarities of the signals are just as well acceptable.

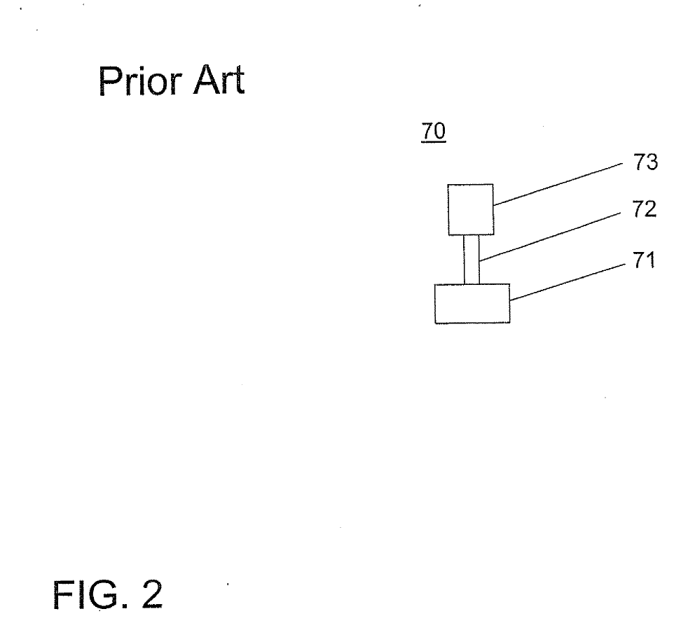

FIG. 5(a) illustrates an enlarged fuse 410, which is an embodiment of the simulated fuse load 110. The enlarged fuse 410 is a structure that is a proportionately enlarged version of an intact electrical fuse 70 in FIG. 2. It comprises an enlarged cathode 411, an enlarged fuselink 412, and an enlarged anode 413. The proportionality factor, that is the ratio of comparable dimensions between similar components between the simulated fuse load 410 and a normal electrical fuse 70 in FIG. 2 is the same for all corresponding components, that is, the ratio of the width of the enlarged cathode 411 of the enlarged fuse 410 to the width of the cathode 71 of the fuse 70, the ratio of the length of the enlarged cathode 411 of the enlarged fuse 410 to the length of the cathode 71 of the fuse 70, the ratio of the width of the enlarged fuselink 412 of the enlarged fuse 410 to the width of the fuselink 72 of the fuse 70, the ratio of the length of the enlarged fuselink 412 of the enlarged fuse 410 to the length of the fuselink 72 of the fuse 70, the ratio of the width of the enlarged anode 413 of the enlarged fuse 410 to the width of the anode 73 of the fuse 70, and the ratio of the length of the enlarged anode 413 of the enlarged fuse 410 to the length of the anode 73 of the fuse 70 are one and the same. Since the number of squares of each component of the enlarged fuse 410 is the same as the number of squares in the corresponding component in the fuse 70, the electrical resistance is the same. The ratio of the dimensions of the enlarged fuse 410 to the corresponding dimensions of an intact fuse 70 in FIG. 2 is greater than 1 and is determined to prevent any change to the fuse 410 materials, that is, by electromigration, rupture, or any other way of permanently altering the electrical properties of the enlarged fuse 410, when passing a sufficient amount of current to program fuse 70 through the enlarged fuselink 410 when the programming transistor 120 in FIG. 3 is turned on. Typically, this ratio is in the range of 2˜4.

FIG. 5(b) illustrates a second embodiment 420 of the simulated fuse load 110 where a 2×2 array of electrical fuses are used to simulate the electrical characteristics of an electrical fuse. A set of two instances 421_A1 and 421_B1 of electrical fuse are connected in series. Another set of two instances 421_A2 and 421_B2 of electrical fuse are connected in series as well. The resistance of each set of two instances of electrical fuses is twice that of one electrical fuse. The second embodiment 420 of the simulated fuse load is formed by connecting the two sets of two instances electrical fuses in parallel with the wiring 431 and the wiring 432. While the second embodiment 420 of the simulated fuse load has the same resistance as one electrical fuse, programming it would require twice as high voltage supply and twice as much current due to its physical size. Therefore, given the same level of programming current as what a normal electrical fuse would require for programming, this embodiment 420 of the simulated fuse load 110 does not program and maintains the electrical characteristics of an intact fuse.

FIG. 5(c) illustrates a second embodiment 440 of the simulated fuse load 110 where a 2×2 array of electrical fuses are used to simulate the electrical characteristics of an electrical fuse. A set of two instances 441_A1 and 441_A2 of electrical fuse are connected in parallel with the wiring 452 and the wiring 454. Another set of two instances 441_B1 and 421_B2 of electrical fuse are connected in parallel with the wiring 451 and the wiring 453 as well. The resistance of each set of two instances of electrical fuses is half that of one electrical fuse. The third embodiment 440 of the simulated fuse load is formed by connecting the two sets of two instances electrical fuses in series with the wiring 455. While the third embodiment 440 of the simulated fuse load has the same resistance as one electrical fuse, programming it would require twice as high voltage supply and twice as much current due to its physical size. Therefore, given the same level of programming current as what a normal electrical fuse would require for programming, this embodiment 420 of the simulated fuse load 110 does not program and maintains the electrical characteristics of an intact fuse.

To provide additional stability against possible effects of the current through the simulated fuse load, an array of increased size may be employed. FIG. 5(d) illustrates a fourth embodiment 460 of the simulated fuse load 110, where an N×N array of electrical fuses are employed, where N is an integer greater than 2. It should be noted that the alphabetical designations for the row is for the convenience in the notation in FIG. 5(d) and that there is no need for the row to use alphabetical notation or alphabetical order. N electrical fuses, that is, 461_Ai, 461_Bi, . . . and 461_Ni, where i is any number between (and including) 1 and N, are connected in series. N of such connections of N fuses are in turn connected in parallel to form an N×N array of fuses, which is the fourth embodiment 460 of the simulated electrical load 110, with the overall resistance equal to that of one electrical fuse. This structure would require N times as high voltage and N times as much current to program compared to a single electrical fuse. Therefore, given the same level of programming current as what a normal electrical fuse would require for programming, this embodiment 460 of the simulated fuse load 110 does not program and maintains the electrical characteristics of an intact fuse.

FIG. 5(e) illustrates a fifth embodiment 480 of the simulated fuse load 110, where an N×N array of electrical fuses are employed, where N is an integer greater than 2. N electrical fuses, that is, 481_X1, 481_X2, . . . and 481_XN, where X is any alphabet between (and including) A and N, are connected in parallel. It should be noted that the alphabetical designations for the row is for the convenience in the notation in FIG. 5(e) and that there is no need for the row to use alphabetical notation or alphabetical order. N of such connections of N fuses are in turn connected in series to form an N×N array of fuses, which is the fifth embodiment 480 of the simulated electrical load 110, with the overall resistance equal to that of one electrical fuse. This structure would require N times as high voltage and N times as much current to program compared to a single electrical fuse. Therefore, given the same level of programming current as what a normal electrical fuse would require for programming, this embodiment 480 of the simulated fuse load 110 does not program and maintains the electrical characteristics of an intact fuse.

Alternatively, a rectangular structure or a maze structure that is manufactured in the same level as the electrical fuse and has the same material composition as the electrical fuse may be tailored to have the resistance as a single electrical fuse may be used instead of the above mentioned specific embodiments of the simulated fuse load 110. Furthermore, any alternative resistive circuit components that electrically resemble an intact electrical fuse in its resistance but do not program (and hence change the resistance) may be substituted for the above mentioned specific embodiments of the simulated fuse load without altering the characteristics of the circuit for determining the optimal gate voltage for programming transistors of the electrical fuses.

In another aspect of this invention, instead of supplying the reference voltage to the comparator externally, circuitries are provided for internally generating the reference voltage from the voltage applied to the F-source power supply. This is done by a connecting a network of circuit elements, connecting one end of the network to the F-source power supply, connecting another end to the ground, and tapping off one node of the network to draw the internally generated reference voltage. Alternatively, a system power supply voltage or battery supplied voltage may be substituted for the F-source power supply.

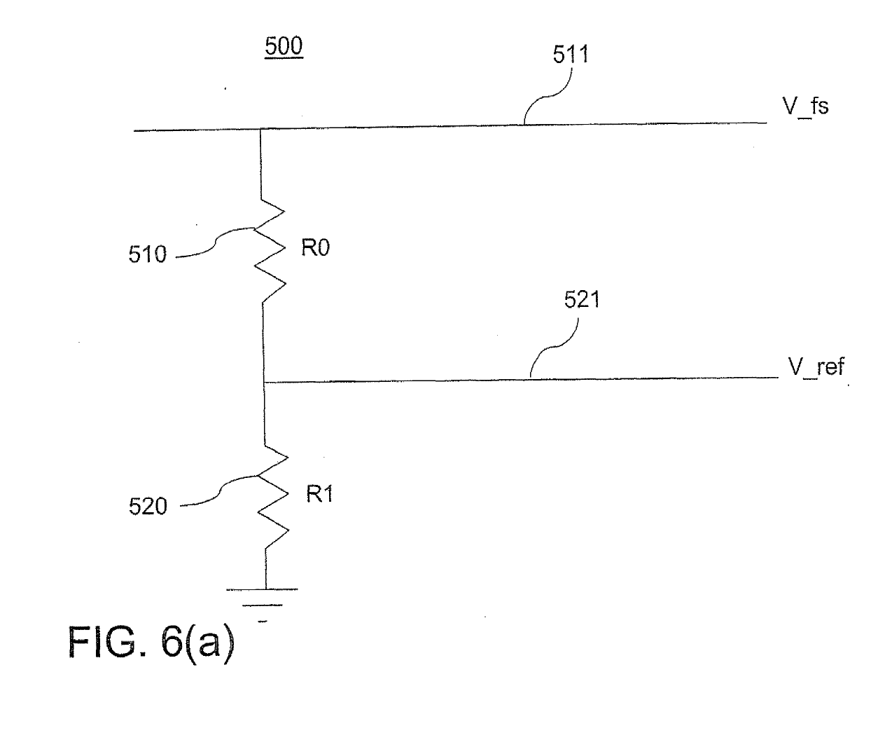

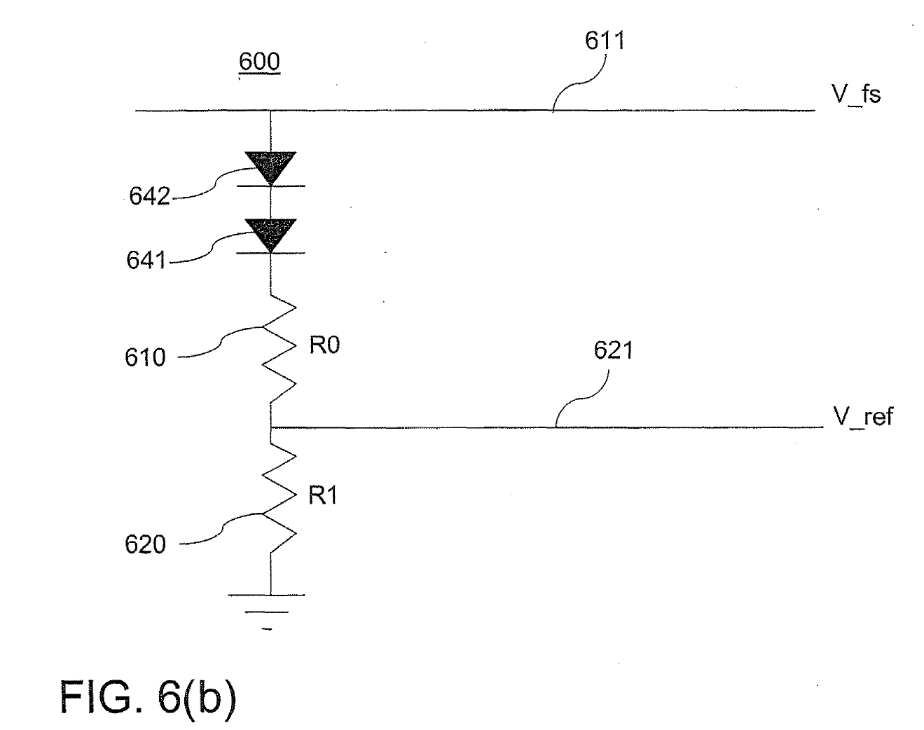

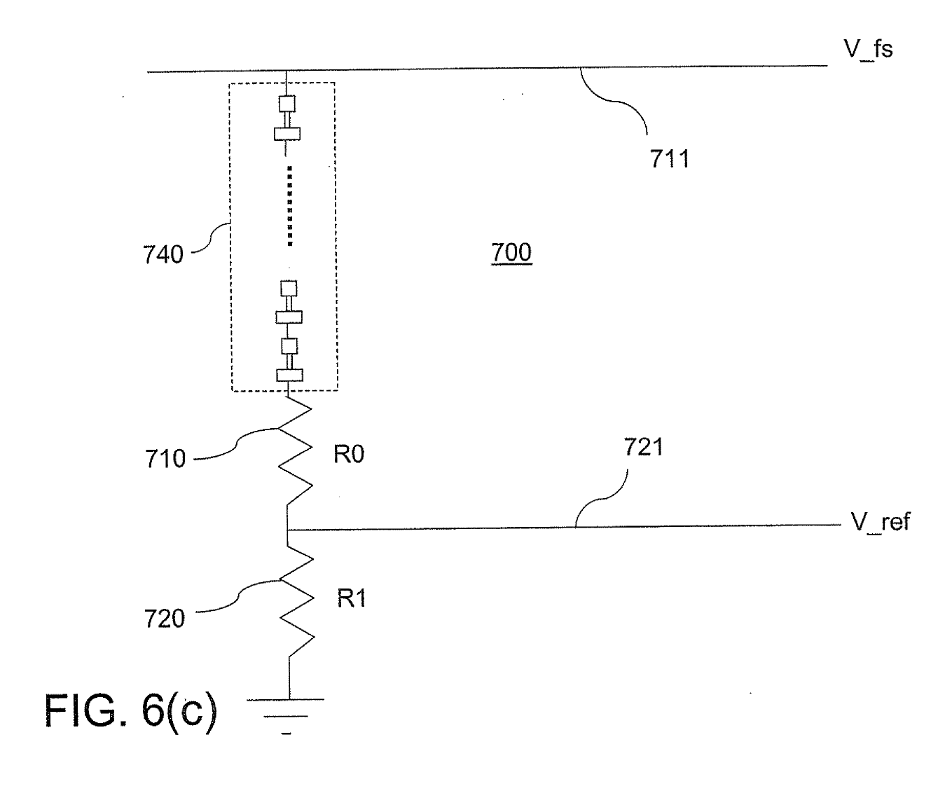

Instead of externally supplying the reference voltage, which is the abscissa of the intersect 231 in FIG. 4, the reference voltage may be generated internally through a voltage divider circuit. FIG. 6(a) illustrates a voltage divider circuit 500 that comprises of two resistors, resistor RO 510 and resistor RI 520 for the internal generation of the reference voltage. One end of the resistor RO 500 is connected to the F-source power supply 511, which is also labeled V_fs. The resistance values of the two resistors are tailored such that the other end of the resistor RO 500 produces the reference voltage on the reference voltage line 521. As described above, the internally generated voltage may be fed into the second input 181 of the comparator 180.

Alternatively, other passive circuit components including diodes and electrical fuses may be used in a voltage divider. FIG. 6(b) illustrates another embodiment of a voltage divider circuit 600 that comprises of at least one diode 640, and two resistors, resistor RO 610 and resistor RI 620 for the internal generation of the reference voltage. The wording, “at least one” diode herein means one diode or multiple diodes and it is schematically represented in FIG. 6(b) with a first diode 641, connected to a dotted line 642, which in turn is connected to a second diode 643 to connote the indefiniteness in the number of diodes. One end of this voltage divider circuit 600 is connected to the F-source power supply 611, which is also labeled V_fs. The resistance values of the two resistors and the number of diodes are tailored such that the reference voltage on the reference voltage line 621 produces a target voltage. Obviously, as many diodes and as many resistors as desired may be utilized to optimize the voltage divider circuit. Furthermore, placement of diodes in other parts of this circuit is expected by a person of ordinary skill in the art.

FIG. 6(c) illustrates still another embodiment of a voltage divider circuit 700 that comprises a network 750 of electrical fuses 740 that contain at least one electrical fuse 740. If tow or more electrical fuses 740 are in the network, they may be connected in a parallel connection, a series connection, or any combination of serial and parallel connections among the fuses. One end of this voltage divider circuit 700 is connected to the F-source power supply 711, which is also labeled V_fs. The resistance values of the two resistors and the number of fuses and internal connections are tailored such that the reference voltage on the reference voltage line 721 produces a target voltage. Compared to the regular resistors, the fuse provides the added advantage of compensating the reference voltage for the variations in the electrical fuse resistance that occur as a result of variations during manufacturing or due to the ambient conditions. Placing multiple networks 740 of electrical fuses 740 or changing the number or placement of resistors within the network is also is expected by a person of ordinary skill in the art.

It should be obvious to one skilled in the art to combine the resistors, diodes, and electrical fuses to generate a voltage divider network that derives the reference voltage from the externally supplied F-source voltage while providing reasonable stability against the variations of circuit components induced by the variations in manufacturing or ambient conditions. Also, it should also be obvious that any external voltage supplied to the system may be substituted for the F-source power supply to generate the reference voltage.

The circuit for determining the optimal gate voltage for programming transistors of the electrical fuses according to the present invention can be incorporated into any programmable electrical fuse circuits incorporated within a processor or embedded memory. Alternatively, it can be implemented in a stand alone product such as a Programmable Read Only Memory (PROM) integrated circuit. In either case, this circuit may be used before packaging on a tester, after packaging at a final module test before shipping the product, or in the field while the product is operational inside a system.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

What is claimed is:

1. A semiconductor circuitry, comprising:
a simulated fuse load which electrically reproduces the resistance of an electrical fuse, but does not program under normal electrical fuse programming conditions;
a programming transistor provided with a gate and attached to said simulated fuse load in a series connection;
a voltage comparator with a first input and a second input;
a reference voltage supply connected to said first input to said voltage comparator;
a counter;
a latch;
a digital to analog voltage converter (DAC) that receives DAC data inputs from said latch and converts said DAC data inputs into a voltage output that is supplied to said gate of said programming transistor; and
a wiring system that transmits and receives signals between said counter, said latch, said digital to analog voltage converter, said gate of said programming transistor, the node between said programming transistor and said simulated fuse load, and said voltage comparator.

2. The semiconductor circuitry of claim 1, where a monotonically changing output is generated from said counter and transmitted to said latch.

3. The semiconductor circuitry of claim 2, further comprising:
a clock input on said counter that accommodates an external clock; and
a reset input on said counter that allows resetting of said counter.

4. The semiconductor circuitry of claim 1, further comprising:
a direct wire connection between said DAC and said gate of said programming transistor.

5. The semiconductor circuitry of claim 1, where said programming transistor is identical in construction to a programming transistor that is used to program electrical fuses in an array.

6. The semiconductor circuitry of claim 1, further comprising:
a direct wire connection between said second input of said voltage comparator and said node between said programming transistor and said simulated fuse load.

7. The semiconductor circuitry of claim 1, further comprising:
a direct wire connection between an output of said voltage comparator and a count enable input of said counter.

8. The semiconductor circuitry of claim 1, further comprising:
a direct wire connection between an output of said voltage comparator and a hold bar input of said latch.

9. The semiconductor circuitry of claim 8, where said hold bar input of said latch is used to trigger a hold mode of said latch, wherein data outputs of said latch thereafter maintain their value independent of changes to data inputs to said latch.

10. The semiconductor circuitry of claim 1, further comprising:
signal buffers that amplify the signal for the transmission over a long wiring distance between any of said simulated fuse load, said programming transistor, said voltage comparator, said first input, said second input, said reference voltage supply, said counter, said latch, said DAC and said wiring system.

11. A semiconductor circuitry of claim 1, wherein said reference voltage is internally generated by a voltage divider circuit.

12. A semiconductor circuitry of claim 11, wherein said voltage divider circuit comprises resistors.

13. A semiconductor circuitry of claim 11, wherein said voltage divider circuit comprises resistors and diodes.

14. A semiconductor circuitry of claim 11, wherein said voltage divider circuit comprises resistors and copies of electrical fuses.

15. A simulated fuse load, which
is located in the same level as electrical fuses;
is made of the same material composition as said electrical fuses;
has the same resistance as a single electrical fuse;
and does not change electrical properties when subjected to a current that would normally program an electrical fuse.

16. A simulated fuse load of claim 15, further comprising:
an enlarged cathode obtained by proportionally enlarging a cathode of electrically programmable fuse by a fixed proportionality factor greater than 1;
an enlarged anode obtained by proportionally enlarging a cathode of electrically programmable fuse by said fixed proportionality factor; and,
an enlarged fuselink obtained by proportionally enlarging a fuselink of electrically programmable fuse by said fixed proportionality factor.

17. A simulated fuse load of claim 15, further comprising:
a parallel connection of two series connections of two electrical fuses.

18. A simulated fuse load of claim 15, further comprising:
a series connection of two parallel connections of two electrical fuses.

19. A simulated fuse load of claim 15, further comprising:
a parallel connection of N series connections of N electrical fuses, where N is an integer greater than 2.

20. A simulated fuse load of claim 15, further comprising:
a series connection of N parallel connections of N electrical fuses, where N is an integer greater than 2.
